(19) United States
(12) Patent Application Publication
(10) Pub. No.: US 2012/0044591 A1
(43) Pub. Date: Feb. 23, 2012

(54) Camera module

(75) Inventor: Sang Jin Lee, Gyeonggi-do (KR)

(73) Assignee: SAMSUNG ELECTRO-MECHANICS CO., LTD., Suwon (KR)

(21) Appl. No.: 13/137,463

(22) Filed: Aug. 17, 2011

(30) Foreign Application Priority Data
Aug. 18, 2010 (KR) 10-2010-0079823

(51) Int. Cl. G02B 7/02

(52) U.S. Cl. 359/819

(57) ABSTRACT

Disclosed herein is a camera module directly mountable on a main substrate without a socket.

A camera module according to the present invention includes a lens barrel having at least one lens stacked therein; a housing having the lens barrel coupled with the upper portion thereof and having a plurality of contactor insertion grooves formed on the lower end surface thereof; and a plurality of contactors mounted in the housing, whereby the mounting process of the camera module can be simplified without using a separate socket and the mounting height of the camera module is lowered by not using the socket to be suitably mounted the camera module in the slim type of electronic products.

### CROSS REFERENCE TO RELATED APPLICATION

This application claims the benefit of Korean Patent Application No. 10-2010-0079823, filed on Aug. 18, 2010, entitled “Camera Module”, which is hereby incorporated by reference in its entirety into this application.

### BACKGROUND OF THE INVENTION

1. Technical Field

The present invention relates to a camera module, and more particularly, to a camera module capable of being mounted on a main substrate without a socket by inserting a contactor into a side portion of a housing configuring the camera module and electrically connecting the main substrate to the contactor.

2. Description of the Related Art

Generally, a camera module may be configured to include a lens group to which light reflected from a subject is input, an image sensor in a CCD or CMOS type converting image signals received through the lens group into electrical signals, a housing in which the image sensor is mounted, and a lens barrel supporting the lens group and coupled with the upper end of the housing.

In addition, the lower portion of the housing is coupled with a substrate on which chip parts, such as capacitor C or resistor R, etc., that are electronic parts for driving the image sensor, are mounted together with the image sensor.

The assembling of camera module is completed by coupling the components, that is, by coupling the image sensor at the designated position using a package process (PKG) or a surface mounting process (SMT) in the state where resistors or capacitors, etc., are mounted on a substrate including a flexible printed circuit board and by fixing the housing and the substrate using a bonding process after an IR filter is mounted in the housing.

Meanwhile, a focus is controlled by positioning a resolution chart at a predetermined distance in front of the lens barrel and by controlling a distance between the lens group mounted in the lens barrel and the resolution chart by rotating the lens barrel, in the state where the lens barrel is temporality fixed by being fastened to the housing by screw connection.

The focus control of the camera module is fixed by controlling a vertical shift amount by rotating a lens barrel to make the shape of the resolution chart sharpest, with disposing a subject, i.e., a resolution chart at a predetermined distance and then bonding the housing to the lens barrel.

Thereafter, whether or not the images generated from the image sensor are abnormal and whether or not the image sensor is polluted due to foreign materials is tested by a separate test process.

As described above, when the assembling and test of the camera module are completed, the camera module is assembled in various types of electronic products, that is, a mobile phone, a game machine, a digital camera, etc., a separate connector, a socket, etc., is used in order to be coupled with the main substrate mounted in electronic products when the camera module is assembled.

In this case, when the camera module is connected to the main substrate through the separate connector, the substrate including a flexible printed circuit board (FPCB) has a predetermined size or more in order to connect the connector, thereby causing the loss of the substrate raw material and the substrate includes the separate connector, thereby increasing material costs.

Further, when using the separate socket vertically coupled with the camera module, the height of the camera module coupled with the socket may be increased due to the basic height of the socket, such that it is difficult to mount the camera module in electronic products that are increasingly slim and the width of the camera module is increased according to the use of the separate socket.

In addition, the camera module coupled with the socket may be separated in the socket due to the external impact, etc., thereby causing the electrical connection defect and the operational defect due to the electrical connection defect.

### SUMMARY OF THE INVENTION

An object of the present invention is to provide a camera module electrically connectable to a main substrate without using a separate socket or a connector coupled to one direction of the camera module by mounting a plurality of contactors in a housing of the camera module in a line to couple the camera module with the main substrate through a contactor.

Further, another object of the present invention is to provide a camera module capable of individually replacing and using the contactor at the time of contactor defect while elastically coupling the contactor coupled with a side wall of a housing to the inside of the housing.

According to an aspect of the present invention, there is provided a camera module, including: a lens barrel having at least one lens stacked therein; a housing having the lens barrel coupled with the upper portion thereof and having a plurality of contactor insertion grooves formed on the lower end surface thereof; and a plurality of contactors mounted in the housing.

The side of the housing of a position corresponding to the contactor inserting groove formed on the lower end surface thereof may be provided with a contactor exposing groove.

The housing may be formed of a hexahedral shape, the central portion thereof may be provided with a barrel insertion hole through which the lens barrel penetrates, and the lower surface thereof may be provided with a two-stage step part.

The contactor may be made of a metal material having elasticity and the contactor may have a step part formed on the upper end thereof, the lower portion of the step part may be provided with a bending part giving elasticity to the upper and lower portions of the contactor, respectively, the lower portion of the bending part may be provided with the substrate contacting part protruded to one side, and the bottom portion thereof may be provided with a main substrate connecting part.

The contactor may have a head part having a predetermined curvature on the upper portion of the step part and the head part may be inserted through the contactor insertion groove of the housing to be inserted into the side wall of the housing.

The step part in the contactor may be elastically hooked and fixed into the contactor exposing groove formed in the housing and the substrate contacting part formed on the lower portion of the bending part of the contactor may contact pads formed on each of the sides of the substrate coupled to the lower portion of the housing.

### BRIEF DESCRIPTION OF THE DRAWINGS

FIG. 1 is a perspective view of a camera module according to the present invention;

FIG. 2 is an assembling perspective view of a camera module according to the present invention;

FIG. 3 is a perspective view of a contactor employed in the camera module of the present invention;

FIG. 4 is a lower perspective view of a housing employed in a camera module according to the present invention;

FIG. 5 is a partially cut perspective view of a state where a contactor is coupled to the housing of the camera module according to the present invention;

FIG. 6 is a partially enlarged cross-sectional view of the camera module according to the present invention; and

FIG. 7 is a cross-sectional view of a main substrate coupling state of the camera module according to the present invention.

### DESCRIPTION OF THE PREFERRED EMBODIMENTS

The acting effects and technical configuration with respect to the objects of a camera module according to the present invention will be clearly understood by the following description in which exemplary embodiments of the present invention are described with reference to the accompanying drawings.

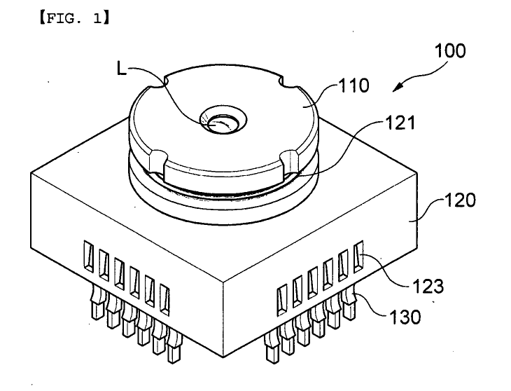

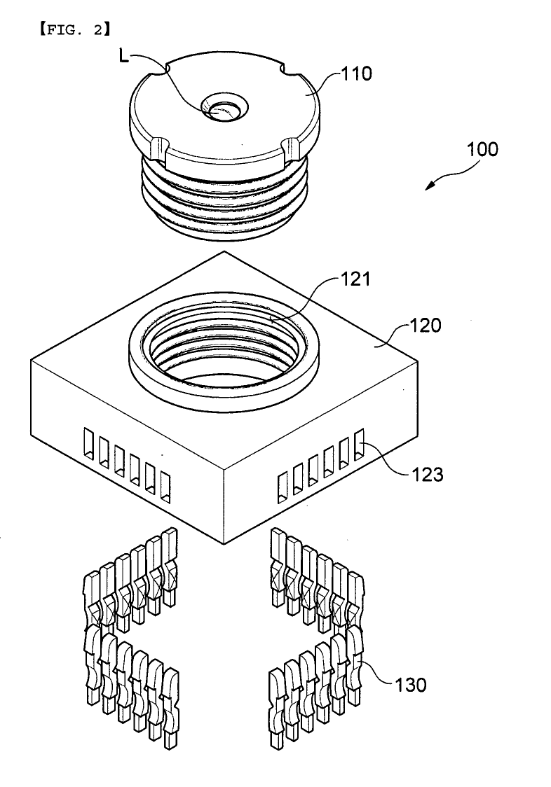

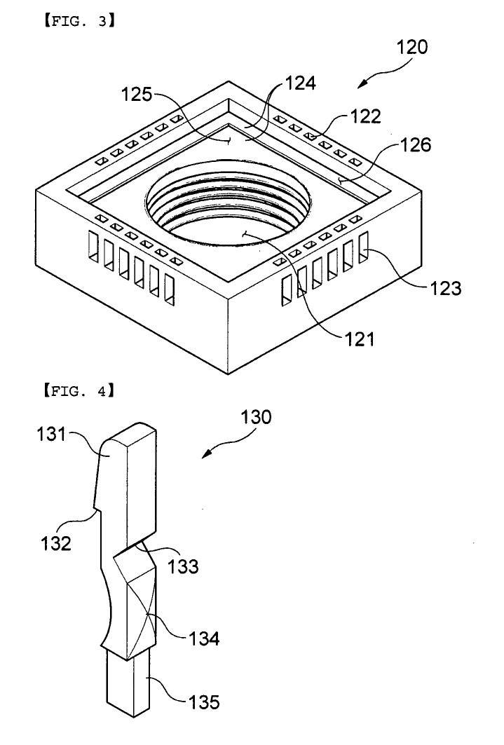

First, FIG. 1 is a perspective view of a camera module according to the present invention, FIG. 2 is an assembling perspective view of the camera module according to the present invention, FIG. 3 is a lower perspective view of a housing employed in the camera module according to the present invention, and FIG. 4 is a perspective view of a contactor employed in the camera module according to the present invention.

As shown in the drawings, a camera module 100 according to exemplary embodiments of the present invention may be configured to include a lens barrel 110 in which a plurality of lenses L are stacked, a housing 120 having the lens barrel 110 inserted into the upper portion thereof, and a plurality of contactors 130 coupled with the housing 120.

The lens barrel 110 collects light reflected from a subject at the outside of the camera module through at least one lenses L coupled therein, wherein the lenses are stacked in the lens barrel 110. Thereafter, the light collected through the lenses L is received in the image sensor, which is converted into image signals.

The lens barrel 110 is coupled with the housing 120. The housing 120 may have a hexahedral shape of which central portion is formed with a barrel insertion hole 121 in a hollow type, the lower end surface of the housing 120 may be formed with a plurality of contactor insertion grooves 122, and each side of the housing 120 may be formed with a contactor exposing groove 123 at positions corresponding to positions at which the contactor insertion grooves 122 are formed.

In this configuration, the contactor insertion grooves 122 and the contactor exposing grooves 123 may be configured to have the same number at the corresponding positions to each other and may be configured to communicate with each other by being formed at the corresponding positions of the lower end surface and side surfaces of the housing 120.

The barrel insertion hole 121 of the housing 120 is vertically coupled with the lens barrel 110 and the lower end surface of the housing 120 may be coupled with the plurality of contactors 130 in a line.

In this case, the lower portion of the housing 120 coupled with the contactor 130 is coupled with the substrate on which the image sensor is mounted as well as the inside of the housing 120 is coupled with an IR filter for blocking excessive infrared rays of light input through the lenses, which will be described in more detail below with reference to the drawings.

The contactor 130 coupled with the housing 120 may made of a conductive metal material and may be formed to have additional elastic force by forming a portion of the contactor 130 in a curved shape, in addition to the inherent elasticity of the metal material.

The upper portion of the contactor 130 is provided with a head part 131 having a predetermined curvature and the lower portion of the head part 131 is provided with a step part 132. In addition, a bending part 133 having an escape groove shape is formed on the opposite surface of the lower portion of the step part 132 at a predetermined depth and the lower portion of the bending part 133 may be sequentially provided with a substrate contacting part 134 and a main substrate connecting part 135.

The head part 131 is inserted into the housing 120 through the contactor insertion groove 122 formed on the lower end surface of the housing 120 and may be easily inserted into the inside of the contactor insertion groove 122 through a curved surface formed at one side of the head part 131.

In addition, the bending part 132 formed on the lower portion of the head part 131 may be formed to provide the additional elasticity to the upper and lower portions of the contactor 130 by the escape groove dug inwardly. The contactor 130 made of an elastic material enables the substrate contacting part 135 formed on the lower portion thereof to elastically contact the side of the substrate to be described below when the substrate contacting part 135 is in contact with the side of the substrate, while being elastically inserted into the contactor insertion groove 122 of the housing 120.

The technical configuration will be described in more detail with reference to the above-mentioned drawings and the drawings to be described below, including the coupling relationship of each component for the camera module of the exemplary embodiment configured as described above.

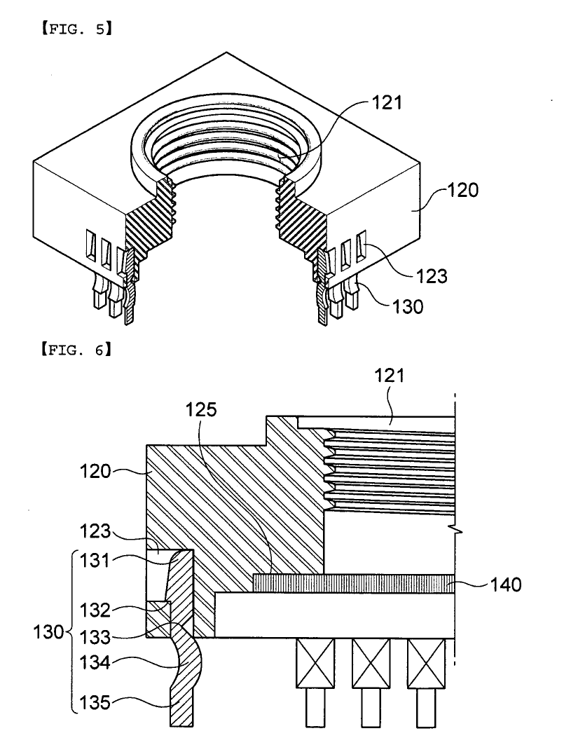

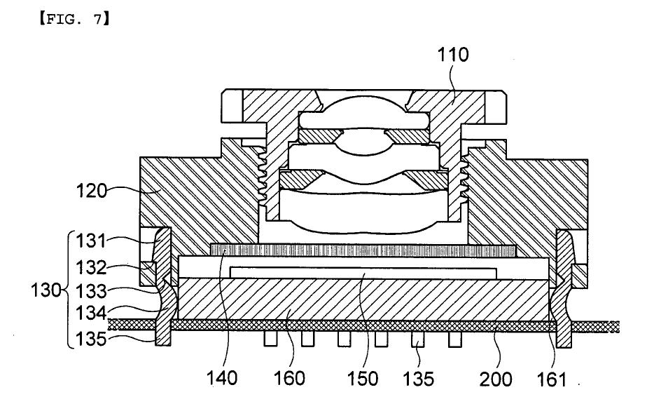

FIG. 5 is a partially cut perspective view of the state where the contactor is coupled to the housing of the camera module according to the present invention, FIG. 6 is a partially enlarged cross-sectional view of a camera module according to the present invention, and FIG. 7 is a cross-sectional view of the state of the main substrate coupling state of the camera module according to the present invention.

As shown, the camera module 100 according to the exemplary embodiment is configured to include the lens barrel 110, the housing 120, and the contactor 130 as described above. The housing 120 is formed in a hexahedral shape in which the barrel insertion hole 121 is formed, wherein the lower surface of the housing 120 may be provided with a two-stage step part 124.

The step part 124 of the housing 120 shown in FIG. 4 may be mounted with the IR filter 140 including the filter seating part 125 to block infrared rays included in light input through the lens L of the lens barrel 110 and the lower side of the IR filter 140 may be provided with a substrate seating part 126 and may be coupled with a substrate 160 on which an image sensor 150 is mounted.

In this configuration, the substrate 160 may be mounted with a printed circuit board (PCB) or a ceramic substrate. The side of the substrate 160 is provided with a side pad 161 to elastically connect to the substrate contacting part 134 formed to be protruded to one side to the plurality of contactors 130 mounted on the housing 120, thereby making it possible to electrically connect the substrate 160 to the contactor 130.

Meanwhile, the plurality of contactors 130 are inserted and fixed into the housing 120 in a line through the plurality of contactor insertion grooves 122 formed on the lower end surface thereof. The step part 132 formed to be protruded to the upper end of the contactor 130 is fixed to be hooked to the contactor exposing groove 123 formed on the side of the housing 120, such that the contactor 130 may be fixed to the contactor insertion groove 122, without being separated therefrom.

The curved surface having a predetermined curvature of the step part 132 is exposed to the outside through the contactor exposing groove 123. In this case, since the contactor 130 itself includes elasticity, the hooking of the step part 132 hooked and fixed to the contactor exposing groove 123 is released by applying an external force to the step part 132 exposed through the contactor exposing groove 123 of the side thereof, such that the contactor 130 is separated in the contactor insertion groove 123, thereby making it possible to easily replace the contactor 130 with a defect when the defect of the contactor 130 occurs.

The external force applied to the step part 132 of the contactor 130 may be applied through a jig in a general pin type. In this case, in order to further give elasticity to the step part 132, the head part 131 of the contactor 130 may be formed in a ring type (not shown).

Meanwhile, the substrate contacting part 134 formed on the lower portion of the contactor 130 is convexly formed in an opposite direction to the step part 132, such that it may be adhered to the side pad 161 formed on the side of the substrate 160 by the elasticity of the bending part 133.

The main substrate connecting part 135 extending to the lower portion of the substrate contacting part 134 penetrates through the main substrate 200 mounted with the camera module by a surface mounting technology (SMT) and is coupled to thereto and the main substrate connecting part 135 penetrating through the through hole of the main substrate 200 is bonded to the rear surface of the main substrate 200 by a soldering to be electrically connected to each other. Therefore, the main substrate 200 and the substrate 160 coupled on the lower portion of the camera module 100 may be electrically connected to each other through the contactor 130.

As described above, the substrate 160 on which the image sensor 150 is mounted is coupled to the lower portion of the housing 120 in the state where the contactor 130 is coupled with the cutting surface of the lower end surface of the housing 120 in a line, the inside of the housing 120 that is the upper portion of the substrate 160 is coupled with the IR filter 140, and the barrel insertion hole 121 of the housing 120 is screw-connected with the lens barrel 110, such that the assembling of the camera module may be completed.

The assembled camera module is mounted on the main substrate 200 in order to be mounted in electronic products such as a mobile phone, etc. In this case, as described above, the plurality of contactors 130 protruded to the lower portion of the housing 120 is inserted through the through hole formed on the main substrate 200 such that the mounting of the main substrate 200 of the camera module 100 is completed. After the camera module 100 is mounted, the electrical connection between the pattern formed on the rear surface of the main substrate 200 and the main substrate connection part 135 coupled with the through hole may be completed by the soldering.

The camera module of the exemplary embodiment configured as described above may be easily mounted by the surface mounting technology without using the separate socket when the camera module 100 is mounted on the main substrate 200, thereby making it possible to individually separate and replace the contactor 130 from the housing 120 when the defect of each contactor 130 coupled with the housing 120 occurs.

As set forth above, the camera module according to the present invention electrically connects the camera module to the substrate by the plurality of contactors each inserted into the lower end of the housing to directly mount the camera module on the main substrate through the contactor, thereby simplify the mounting process of the camera module without using the separate socket and does not need to use the socket to lower the mounting height of the camera module, thereby making it possible to suitably mount the camera module in the electronic products.

Further, the camera module according to the present invention can individually replace the contactor with defect when a defect occurs in any one of the plurality of contactors coupled to the lower end surface of the housing, thereby making it possible to individually replace the contactor with a defect and save production costs

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A camera module, comprising:
a lens barrel having at least one lens stacked therein;
a housing having the lens barrel coupled with the upper portion thereof and having a plurality of contactor insertion grooves formed on the lower end surface thereof; and
a plurality of contactors mounted in the housing.

2. The camera module according to claim 1, wherein the side of the housing of a position corresponding to the contactor inserting groove formed on the lower end surface thereof is provided with a contactor exposing groove.

3. The camera module according to claim 2, wherein the contactor insertion groove and the contactor exposing groove are formed in the same number and are configured to be communicated with each other.

4. The camera module according to claim 1, wherein the housing is formed of a hexahedral shape, the central portion thereof is provided with a barrel insertion hole through which the lens barrel penetrates and the lower surface thereof is provided with an two-stage step part.

5. The camera module according to claim 4, wherein the two-stage step part is formed of a filter seating part in which an IR filter is seated and a substrate seating part in which the substrate is seated.

6. The camera module according to claim 1, wherein the contactor is made of a metal material having elasticity.

7. The camera module according to claim 1, wherein the contactor has a step part formed on the upper end thereof, the lower portion of the step part is provided with a bending part giving elasticity to the upper and lower portions of the contactor, respectively, the lower portion of the bending part is provided with the substrate contacting part protruded to one side, and the bottom portion thereof is provided with a main substrate connecting part.

8. The camera module according to claim 7, wherein the contactor has a head part having a predetermined curvature on the upper portion of the step part and the head part is inserted through the contactor insertion groove of the housing to be inserted into the side wall of the housing.

9. The camera module according to claim 7, wherein the step part is elastically hooked and fixed into the contactor exposing groove formed in the housing.

10. The camera module according to claim 7, wherein the substrate contacting part contacts pads formed on each of the sides of the substrate coupled to the lower portion of the housing.
